(19) United States
(12) Patent Application Publication
(10) Pub. No.: US 2009/0207319 A1
(43) Pub. Date: Aug. 20, 2009

(54) Apparatus which converts remote control signal, remote controller, remote control apparatus, and remote control method

(75) Inventors: Yoshinori SATOH, Saitama (JP); Masahiro NAKANO, Tokyo (JP); Kazunori KIKUCHI, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/378,531

(22) Filed: Feb. 17, 2009

(30) Foreign Application Priority Data
Feb. 18, 2008 (JP) 2008-036160

(51) Int. Cl. H04N 5/44

(52) U.S. Cl. 348/734; 348/E05.096

(57) ABSTRACT

A remote-control-signal conversion apparatus is disclosed. The remote-control-signal conversion apparatus receives a radio control signal from a remote controller, converts the radio control signal into an infrared control signal, and transmits the infrared control signal to an external device. When the apparatus identifies the external device, the apparatus transmits a plurality of infrared control signals to the external device. The apparatus identifies device identification information of the external device based on a response from the external device. The apparatus radio transmits the identified device identification information to the remote controller. The apparatus transmits the device identification information and a control code corresponding thereto as the infrared control signal received from the remote controller to the external device. The apparatus transmits the infrared control signal to the external device.

### CROSS REFERENCES TO RELATED APPLICATIONS

The present invention contains subject matter related to Japanese Patent Application JP 2008-036160 filed in the Japanese Patent Office on Feb. 18, 2008, the entire contents of which being incorporated herein by reference.

### BACKGROUND OF THE INVENTION

1. Field of the Invention

The present invention relates to an apparatus which converts a remote control signal, a remote controller, a remote control apparatus, and a remote control method applied to remote controlling for an electronic apparatus, for example, based on a radio communication system.

2. Description of the Related Art

To remotely control an in-home apparatus under control, for example, a television receiver, when 2.4 GHz band Industrial, Scientific and Medical (ISM) use band is used, as its advantages, it is less affected by shadings and has longer range than an infrared system. In addition, since the reception side returns an acknowledge to the controller side, even if it fails to communicate with the reception side, it retransmits a control signal to the reception side. As a result, the user's operation can be securely transmitted to the reception side.

Such a remote control apparatus may control a device disposed in an adjacent room or a next door house without user's intension. Thus, when the user purchases and sets up a television receiver, it is necessary to correlate the remote control apparatus (hereinafter referred to as the remote controller) and the television receiver to allow the user to control the television receiver (this operation is referred to as pairing). Pairing means exchanging of identification information (ID) of the remote controller and that of the electronic device under control.

FIG. 1A and FIG. 1B generally describe an RF type remote control apparatus. As shown in FIG. 1A, a remote controller 100 has an antenna 101 that transmits and receives a radio wave; a microprocessor (hereinafter referred to as the central processing unit (CPU)) 102 as a control section that performs a communication function and read/write operations for a storage medium and executes programs according to various key inputs; a communication section 103 (corresponding to a communication section 11 of an embodiment of the present invention) that performs radio communication; a storage medium 104 that stores identification information ID of a pairing party; a storage medium 105 that stores an ID of the remote controller 100 and a category code of an electronic device with which the remote controller 100 initially pairs; and a key input section 106 that has keys. The storage mediums 104 and 105 each are composed of a writable non-volatile memory. The CPU 102 has a read-only memory (ROM), a random access memory (RAM), and so forth and totally controls each section of the remote controller 100 by executing programs stored in the ROM and so forth.

As shown in FIG. 1B, a reception apparatus 110 disposed in the device under control has an antenna 111 that transmits and receives a radio wave; a CPU 112 that performs a communication function and read/write operations for a record medium and executes programs according to various key inputs; a communication section 113 that performs radio communication; a storage medium 115 that stores identification information ID of a pairing party; a storage medium 116 that stores an ID and a category code of the reception apparatus 110 (for example, a code that represents a category of a television receiver); and an external interface 117 that interfaces, for example, with a television receiver. The CPU 112 totally controls each section of the reception module 110. The storage mediums 115 and 116 each are composed, for example, of a non-volatile memory.

The communication section 103 of the remote controller 100 and the communication section 113 of the reception apparatus 110 bidirectionally communicate with each other according to a predetermined radio communication system. The communication system is, for example, Institute of Electrical and Electronics Engineers (IEEE) 802.15.4. The reception apparatus 110 has a function that outputs a command received through the radio remote control to an electronic device, for example, a television receiver to which the external interface is connected. IEEE 802.15.4 is the name of a short range radio network called personal area network (PAN) or wireless PAN (WPAN).

The communication rate of this standard is from several 10 kbps to several 100 kbps and the communication distance ranges from several 10 m to several 100 m. Communication is made frame by frame. One frame is composed of a maximum of 133 bytes of a payload (0 to 127 bytes) and a header (6 bytes). In this communication system, a plurality of transmission and reception forms can be used. In the remote control system, the simplest method is used. Namely, the remote control apparatus transmits a command to the device under remote control and receives a response therefrom. Instead, a more complex transmission/reception system may be used.

The foregoing RF type remote control apparatus has not become common in comparison with the infrared (hereinafter abbreviated as Ir) type remote control apparatus. Even if the remote controller is intended to be shared with a plurality of devices, existing Ir type devices are difficult to be controlled by an RF type remote controller.

As one method of solving this problem, as shown in FIG. 2, an RF signal is transmitted from a communication section 11 of an RF type remote controller 10 to a conversion apparatus 50 which converts the remote control signal, for example, built in a television receiver. An external device 41 is controlled from the conversion apparatus 50 through a digital interface section 52. The conversion apparatus 50 is controlled by the remote controller 10. The remote controller 10 has a key set 20. A control signal corresponding to a key operation for the key set 20 is radio transmitted to a communication section 31 of the conversion apparatus 50. A control section 32 controls a process of the conversion apparatus 50. The control section 32 and a digital interface section 52 are connected and a control signal is exchanged therebetween.

The digital interface section 52 is connected to the external device 41 through a cable 51. The digital interface section 52 is, for example, High-Definition Multimedia Interface (HDMI). HDMI is specifications for an interface of base-band video data, audio data, and control signals. When the external device 41, for example, a Blu-ray Disc recorder starts reproduction using the function of HDMI, the television receiver can be controlled, for example, to automatically display reproduced video data. In FIG. 2, paths for video data and audio data are omitted.

The control section 32 of the conversion apparatus 50 can obtain device identification information of the external device 41 through the cable 51 and the digital interface section 52. The device identification information is identification information that identifies the external device 41. Specifically, the device identification information is a manufacturer name and a device type name. Instead or in addition, the device identification information may be information about production year. The control section 32 radio transmits the obtained device identification information to the remote controller 10 through the communication section 31. The remote controller 10 receives the device identification information and identifies the external device 41 connected to the conversion apparatus 50 based on the device identification information.

The remote controller 10 has a read-only memory (ROM) that has stored a table of control codes for a plurality of external devices (products) (although they may be referred to as remote controller codes, they are referred to as preset codes in this specification). Thus, the table of preset codes corresponding to device identification information received from the conversion apparatus 50 has been set up in the ROM.

A preset code corresponding to an operation for the key set 20 is read from the ROM and is supplied as an RF signal to the communication section 31 of the conversion apparatus 50. The control section 32 generates a control command according to the received RF signal and supplies the control command to the external device 41 through the digital interface section 52 and the cable 51. The external device 41 is controlled according to the control command.

The method of converting such an RF signal into a control signal for an interface control signal may not be used unless the external device 41 has a predetermined digital interface. To solve this problem, a conversion apparatus that converts an RF type control signal (RF signal) into an infrared signal (Ir signal) may be used (hereinafter, this conversion apparatus is referred to as the blaster apparatus).

As proposed in Japanese Patent Laid-Open Publication No. 2005-198115, referred to as Patent Document 1, a reception apparatus that receives an Ir signal from an Ir type remote controller is disposed in a television receiver. The reception apparatus supplies the received control signal to the Ir blaster apparatus. The Ir blaster apparatus transmits the Ir control signal to an external device such as a video cassette recorder (VCR) connected to the television receiver to control the external device.

FIG. 3 exemplifies a structure of a related art that uses a blaster apparatus 30 that converts an RF signal into an Ir signal. The remote controller 10 is used to control a television receiver. The remote controller 10 radio transmits an RF signal corresponding to a key operation of the key set 20. The control section 32 controls a process of the blaster apparatus 30. The external device 41 is connected to an input terminal 53 of the television receiver 54 through an analog or digital interface. When the remote controller 10 is used to control the external device 41, the remote controller 10 is necessary to be initially set up.

A conversion section 33 converts an RF signal received by the communication section 31 of the blaster apparatus 30 into an Ir signal under the control of the control section 32 and supplies the Ir signal to a light emitting device 35 that is an Ir generation section. Infrared light emitted from the light emitting device 35 is radiated to a photo receptor (not shown) of the external device 41. The photo receptor generates a control signal for the external device 41 based on the received infrared light. The blaster apparatus 30 has a memory (non-volatile memory) 34 that has stored a table of a plurality of preset codes for a plurality of device types of a plurality of manufacturers.

The remote controller 10 has the same structure as that of the remote controller 100 shown in FIG. 1A. The communication section 31 and the control section 32 of the blaster apparatus 30 have the same structures as those of the reception module 110 shown in FIG. 1B. The remote controller 10 has an operation key set 20 that includes device designation keys. With the device control keys, the user can selectively control the television receiver 54 or the external device 41.

When the television receiver 54 is controlled, a device under control is set for the television receiver 54 with a device designation key of the remote controller 10. The blaster apparatus 30 receives device identification information of the device under control (television receiver 54) from the remote controller 10 and sets up a table of preset codes of the memory 34 for the television receiver 54. An RF signal corresponding to an operation key of the key set 20 is transmitted to the blaster apparatus 30. The television receiver 54 is controlled with preset codes based on the table received from the blaster apparatus 30.

When the external device 41 is controlled with the remote controller 10, the external device 41 is selected with a device designation key and a table of preset codes stored in the memory 34 is set up for the external device 41. An RF signal corresponding to the operation key of the key set 20 is transmitted to the blaster apparatus 30. The memory 34 generates a preset code, the present code is converted into an Ir signal, and the Ir signal is emitted as infrared light from the light emitting device 35 to the photo receptor of the external device 41. The Ir signal is composed of a preset code and necessary additional information. Since Ir signal formats depend on manufactures, an Ir signal is generated in the format of the designated manufacturer. Infrared light is generated from the light emitting device 35 corresponding to the Ir signal.

The external device 41 connected to the input terminal 53 of the television receiver 54 may be one of various device types of various manufacturers. When the external device 41 is controlled, an Ir signal that the blaster apparatus 30 outputs is necessary to match the manufacturer and device type of the external device 41.

In the past, a manufacturer code list (or an instruction manual) 12 was prepared. With reference to the list, the remote controller 10 was initially set up to control the external device 41. For example, the device designation keys (input buttons) of the remote controller 10 were used for a plurality of keys for various device types. For example, a television receiver designation key, a digital versatile disc (DVD) designation key, a Blu-ray Disc (BD) designation key, and a video cassette recorder (VCR) designation key were provided. Among these keys, a key corresponding to the connected external device 41 was assigned.

If the remote controller 10 was packaged along with the television receiver 54, since the manufacturer name of the television receiver 54 had been set up, the television receiver 54 was not necessary to be initially set up. If the external device 41 was for example a DVD recorder, the DVD designation key was assigned to the external device 41. As an example of real operation, a predetermined key was pressed while the DVD designation key was being pressed to enter the initial set mode. With reference to the list 12, a manufacturer number was checked and a numeric key corresponding to the manufacturer number was pressed. After keys had been input, an OK key was pressed to complete the initial setting. In other words, the DVD designation key was set for a DVD recorder of a particular manufacturer.

Thus, when the DVD designation key was pressed, device identification information of the DVD recorder was transmitted to the blaster apparatus 30. Thereafter, a signal corresponding to a key pressed in the key set 20 was transmitted to the blaster apparatus 30. The blaster apparatus 30 transmitted an Ir signal corresponding to the key to the external device 41.

### SUMMARY OF THE INVENTION

When the user was necessary to initially set up the remote controller 10 for the external device 41 with a key of the remote controller 10 while he or she was watching a list, it imposed a burden on him or her. If the user was likely to mistakenly press a key, he or she was necessary to repeat the bothersome setup operation again. Patent Document 1 describes an initial setting method in which the user operates a remote controller while watching a device designation menu on a display screen of a television receiver to select a device type and a manufacturer and set up a device. However, the initial setting method in which the user sets up the remote controller with the menu instead of the list was difficult because he or she was necessary to perform a key operation of the remote controller.

In view of the foregoing, it would be desirable to provide an apparatus that converts a remote control signal, a remote controller, a remote control apparatus, and a remote control method that allow an RF type remote controller to initially set up an external device without necessity of user's bothersome key operations.

According to an embodiment of the present invention, there is provided a remote-control-signal conversion apparatus which receives a radio control signal from a remote controller, converts the radio control signal into an infrared control signal, and transmits the infrared control signal to an external device. When the apparatus identifies the external device, the apparatus transmits a plurality of infrared control signals to the external device. The apparatus identifies device identification information of the external device based on a response from the external device. The apparatus radio transmits the identified device identification information to the remote controller. The apparatus transmits the device identification information and a control code corresponding thereto as the infrared control signal received from the remote controller to the external device. The apparatus transmits the infrared control signal to the external device.

It is preferred that one of the plurality of device control keys be correlated with the device identification information.

The device identification information of the external device is a code which represents a manufacturer name and a device type.

For automatic initial setup, when the apparatus is connected to a signal output terminal of the external device and the apparatus successively transmits a plurality of the infrared control signals to the external device, the apparatus identifies the device identification information based on signal changes of the signal output terminal.

For semi-automatic initial setup, when the apparatus successively transmits the plurality of infrared control signals to the external device, the device identification information of the external device is identified based on changes of an indication of the external device.

According to an embodiment of the present invention, there is provided a remote controller which transmits a radio control signal to an external device and controls it based on the radio control signal. The remote controller receives device identification information from a remote-control-signal conversion device and converts the radio control signal into an infrared control signal. One of the plurality of device designation keys is correlated with the device identification information.

According to an embodiment of the present invention, there is provided a remote control apparatus. The remote control apparatus includes a remote controller and a remote-control-signal conversion apparatus. The remote-control-signal conversion apparatus receives a radio control signal from the remote controller, converts the radio control signal into an infrared control signal, and transmits the infrared control signal to an external device. When the apparatus identifies the external device, the apparatus transmits a plurality of infrared control signals to the external device. The apparatus identifies device identification information of the external device based on a response from the external device. The apparatus radio transmits the identified device identification information to the remote controller. The apparatus transmits a radio control signal as the infrared control signal received from the remote controller to the external device. The remote controller receives device identification information from the remote-control-signal conversion device. One of the plurality of device designation keys is correlated with the device identification information. The remote controller transmits the device identification information designated by the device designation key to the remote-control-signal conversion apparatus.

According to an embodiment of the present invention, there is provided a remote control method. A remote-control-signal conversion apparatus transmits a plurality of infrared control signals to an external device when the apparatus identifies the external device. The apparatus identifies device identification information of the external device based on a response from the external device. The apparatus radio transmits the identified device identification information to the remote controller. The apparatus transmits a radio control signal as the infrared control signal received from the remote controller to the external device. The remote controller receives device identification information from the remote-control-signal conversion device. The remote controller correlates one of the plurality of device designation keys with the device identification information. The remote controller transmits the device identification information designated by the device designation key to the remote-control-signal conversion apparatus.

According to embodiments of the present invention, a remote controller can automatically or semi-automatically obtain device identification information of an external device without necessity of intervention of a digital interface. Thus, bothersome key operations can be omitted.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1A and FIG. 1B are block diagrams showing structures of an RF type remote controller and its reception module of a related art;

FIG. 2 is a block diagram exemplifying a remote control apparatus of a related art;

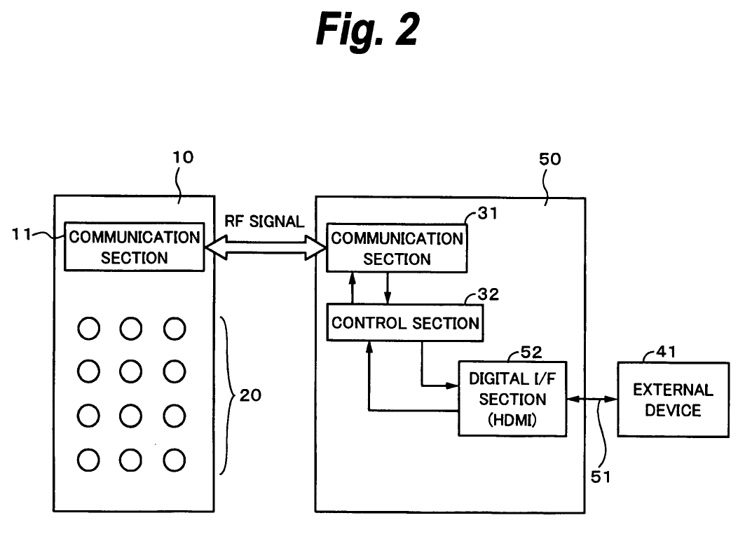

FIG. 3 is a block diagram describing another remote control apparatus of a related art;

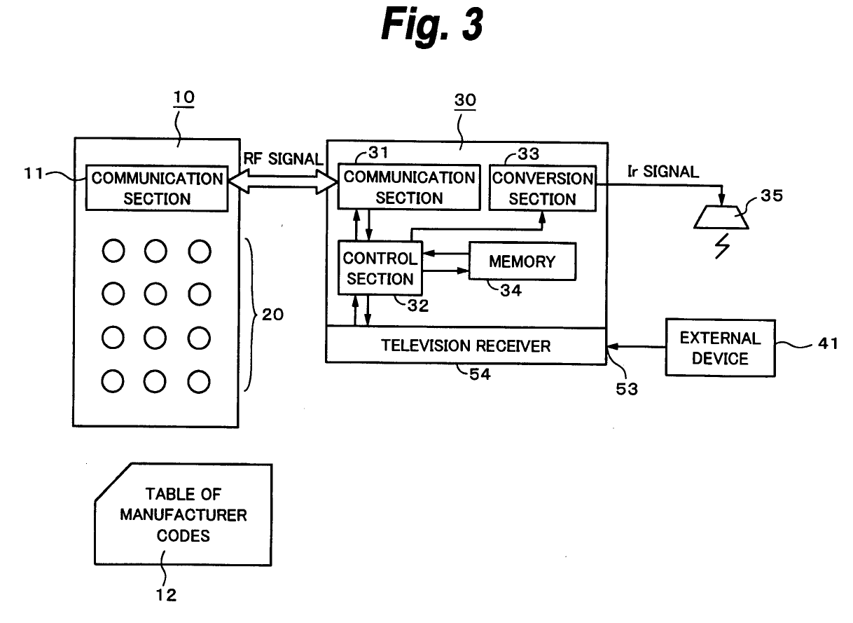

FIG. 4 is a block diagram showing structures of a remote controller and a blaster apparatus according to a first embodiment of the present invention;

FIG. 5 is a schematic diagram exemplifying a key arrangement of the remote controller according to the first embodiment of the present invention;

FIG. 6 is a schematic diagram describing preset codes;

FIG. 7 is a flow chart showing a process of the first embodiment of the present invention;

FIG. 8 is a flow chart showing a process of a second embodiment of the present invention;

FIG. 9 is a flow chart showing a process of a third embodiment of the present invention; and

FIG. 10 is a block diagram exemplifying other structures a remote controller and a blaster apparatus according to another embodiment of the present invention.

### DETAILED DESCRIPTION OF THE PREFERRED EMBODIMENTS

Next, with reference to the accompanying drawings, a first embodiment of the present invention will be described. Although these embodiments that will be described in the following are preferred ones of the present invention and various technically preferably limitations are imposed thereto, it is appreciated that the scope of the present invention is not limited to these embodiments unless described that they impose the present invention.

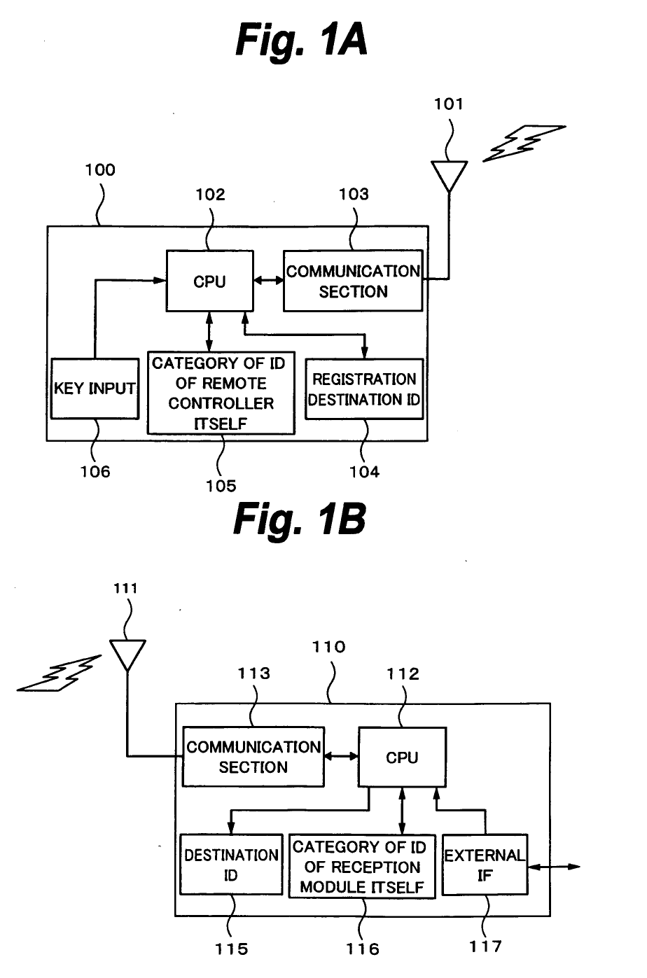

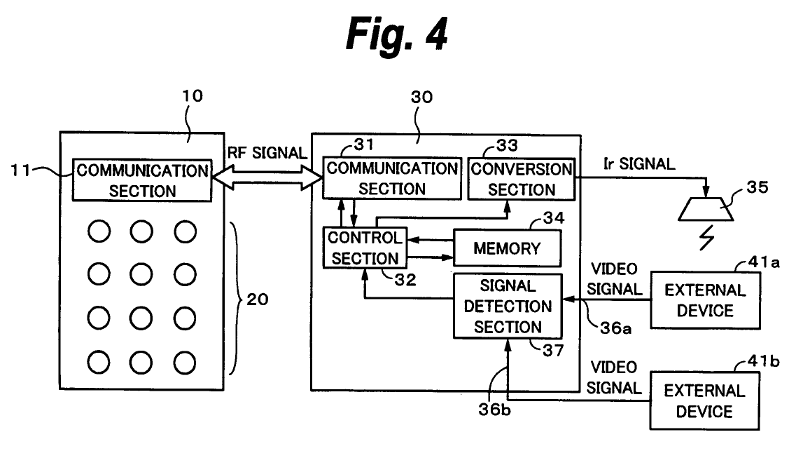

As shown in FIG. 4, a blaster apparatus 30 that converts an RF signal (radio control signal) transmitted from a remote controller 10 into an Ir signal (infrared control signal). The remote controller 10 and the blaster apparatus 30 are paired such that they bidirectionally radio communicate with each other. The radio communication structures of the communication section 11 and the communication section 31 are the same as those of the RF type remote controller and its reception module of the related art described with reference to FIG. 1A and FIG. 1B.

The blaster apparatus 30 controls, for example, a television receiver. The blaster apparatus 30 is built in a television receiver (not shown). Thus, the remote controller 10 can remotely control a television receiver based on an RF remote control system with a key operation of a key set 20. However, the blaster apparatus 30 may be structurally separated from the television receiver. Thus, one of external devices that are devices under control of the blaster apparatus 30 may be a television receiver. In this case, a television receiver may be connected to the blaster apparatus 30 through a digital interface, for example, HDMI. A control section 32 can obtain device identification information about an external device through a digital interface such as HDMI. The control section 32 transmits the obtained device identification information to the remote controller 10.

A process of the blaster apparatus 30 is controlled by the control section 32. The control section 32 is a microcomputer composed of, for example, a central processing unit (CPU), a read-only memory (ROM), a random access memory (RAM), and so forth. The control section 32 executes programs stored, for example, in the ROM to totally control each section of the blaster apparatus 30. In other words, the control section 32 controls transmission and reception operations of the communication section 31, refers to the memory 34, and outputs a preset code corresponding to the received signal to a conversion section 33. The conversion section 33 generates an Ir signal corresponding to the preset code. The memory 34 is a non-volatile memory that has stored preset codes of a plurality of device types of a plurality of manufacturers. Instead, a table of preset codes may be obtained through the Internet, a storage medium, or the like and the obtained table of preset codes may be stored in the memory 34.

External devices 41a and 41b are connected to input terminals 36a and 36b of the blaster apparatus 30 (television receiver). Video signals that are output from the external devices 41a and 41b are supplied to a signal detection section 37 of the blaster apparatus 30. A selector (not shown) is disposed between the input terminals 36a and 36b and the control section 32 controls the selector to select one of video signals of the external devices 41a and 41b. A video signal selected by the selector is supplied to a signal process section (not shown) of the television receiver and displayed on a monitor screen (not shown).

The external devices 41a and 41b each have a photo receptor of an Ir type remote control apparatus. The photo receptor receives infrared light emitted by the light emitting device 35 of the blaster apparatus 30. The external devices 41a and 41b are controlled to operate with a signal corresponding to the received infrared light.

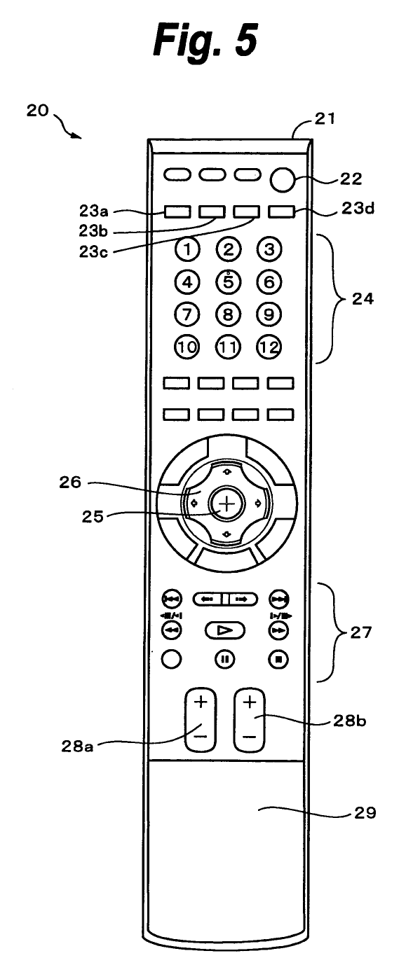

Next, the key set 20 of the remote controller 10 will be exemplified. FIG. 5 exemplifies a structure of the remote controller 10. The remote controller 10 has a plurality of operation keys disposed on the front surface of the housing, a transmission section 21 that transmits transmission signals such as infrared light, radio wave, or the like, and a shutter 29 that can slidably open and close another operation key pad (not shown).

The key set 20 includes a power on/off key 22, device designation keys 23a, 23b, 23c, and 23d, a numeric key set 24, an OK key 25, a direction key set 26, an AV device operation key set 27 (including a reproduction key and a stop key), a volume adjustment key 28a, and a channel key 28b.

The device designation keys 23a, 23b, 23c, and 23d correspond to individual device types. The device designation key 23a is assigned to a television receiver. The device designation key 23b is assigned to a Blu-ray Disc (BD) recorder, a DVD receiver, or a HDD recorder. The device designation key 23c is assigned to a tuner. The device designation key 23d is assigned to another device. In addition, the device designation keys 23a, 23b, 23c, and 23d control the status of the selector (not shown) to which external devices of the blaster apparatus 30 are connected. When any of the device designation keys is pressed, the selector selects one input corresponding to the selected device designation key.

The device designation keys 23a, 23b, 23c, and 23d of the remote controller 10 may not correspond to device types, but to input terminals of the selector of the blaster apparatus 30 (television receiver). However, if the device designation keys 23a, 23b, 23c, and 23d are correlated with device types, when device identification information of an external device is obtained, the types of the external devices can be narrowed down.

When the remote controller 10 is initially set up as will be described later, the device designation keys 23a, 23b, 23c, and 23d are correlated with the external devices that have been actually connected to the blaster apparatus 30. At factory, the device designation keys 23a, 23b, 23c, and 23d may have been assigned to devices manufactured by the same manufacturer as the remote controller 10. After the remote controller 10 has been initially set up, when one of the device designation keys 23a, 23b, 23c, and 23d is pressed, the device identification information that identifies a device under the control of the remote controller 10 is radio transmitted to the blaster apparatus 30. When each of the device designation keys 23a, 23b, 23c, and 23d is pressed, its LED lights, indicating that the device designation key has been pressed. When another key is operated, a device designation key corresponding to a status that has been set up lights up for a short time.

The remote controller 10 transmits an RF signal containing device identification information to the blaster apparatus 30. The control section 32 of the blaster apparatus 30 selects a table that represents the relationship of a key stored in the memory 34 and a preset code (that represents a control content) based on the received. Thereafter, the control section 32 converts the received signal corresponding to the pressed key into a preset code with reference to the selected table and supplies the preset code to the conversion section 33. The conversion section 33 converts the preset code into an Ir signal, supplies it to the light emitting device 35, and the light emitting device 35 emits infrared light. One of the external devices 41a and 41b that has received infrared light decodes the Ir signal into a preset code and the external device is controlled according to the preset code.

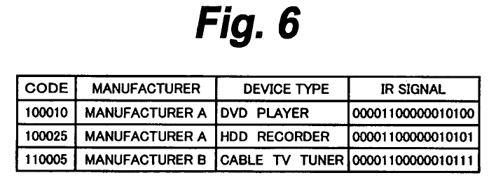

As outlined in FIG. 6, a code (numeric value) corresponding to device identification information represents a manufacturer name and a device type. In the past, the list described manufacturer numbers and corresponding numeric values for individual device types. The user set up a device assigned to a device designation key by inputting a relevant numeric value with a numeric key of the remote controller. This code is used to identify the table stored in the memory 34. Ir signals shown in FIG. 6 are signal that occurs, for example, whenever the power on/off key 22 is pressed. Ir signals that occur depend on device types. The remote controller 10 may be provided with power on/off keys for individual devices along with the main power on/off key 22.

The table stored in the memory 34 is much more complicated than that shown in FIG. 6. In other words, preset codes have been assigned to all keys of the key set 20 of the key set 20 except for the power on/off key. When the device type is, for example, a television receiver, preset codes corresponding to individual manufactures have been assigned to the power on/off key 22. Likewise, preset codes corresponding to individual manufactures have been assigned to other numeric keys (channel number keys), volume increase and decrease of the volume adjustment key 28a, and channel increase and decrease of channel number. Thus, when the remote controller 10 has transmitted device identification information that represents a device type and a manufacturer name and also a code that represents a key that had been pressed, a corresponding preset code is read from the memory 34 and supplied to the conversion section 33. The conversion section 33 converts the preset code into an Ir signal corresponding to the relevant manufacturer. The light emitting device 35 puts out or lights up corresponding to 0s/1s of the Ir signal.

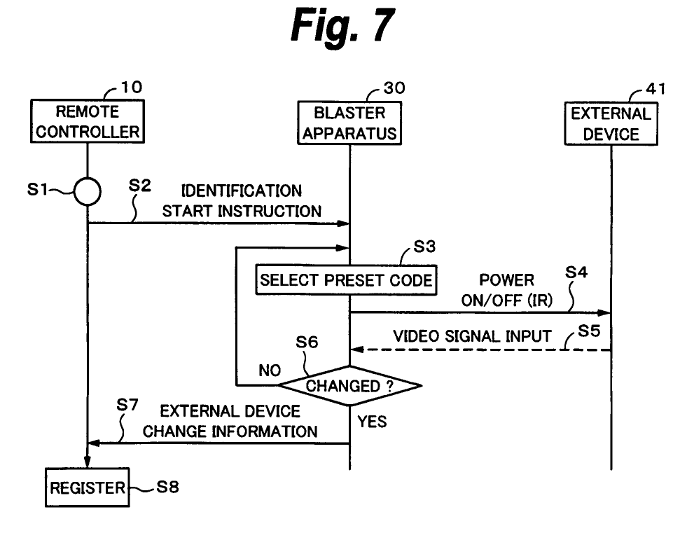

Next, with reference to a flow chart shown in FIG. 7, an initial setup process according to the first embodiment of the present invention will be described. First, at step S1, any key of the device designation keys 23a, 23b, 23c, and 23d and the OK key 25 are pressed simultaneously on the remote controller 10. At step S2, an RF signal containing an identification start instruction command is transmitted from the remote controller 10 to the blaster apparatus 30.

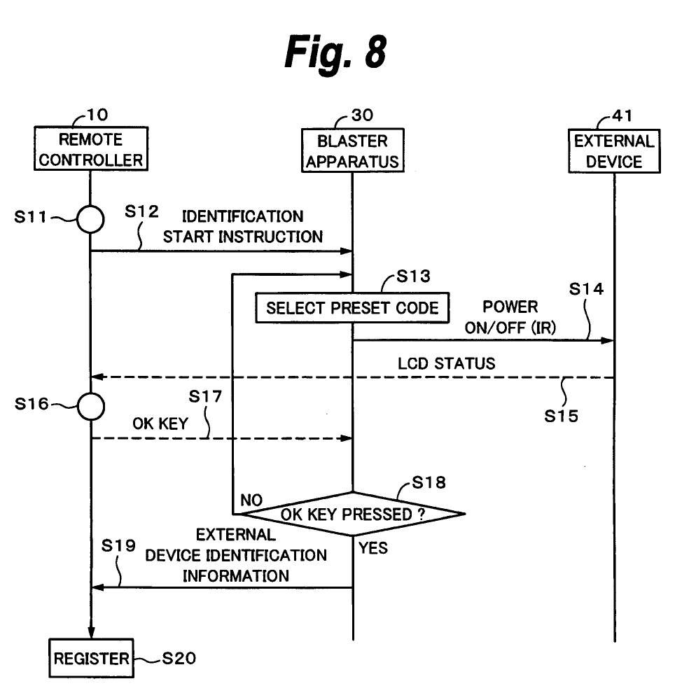

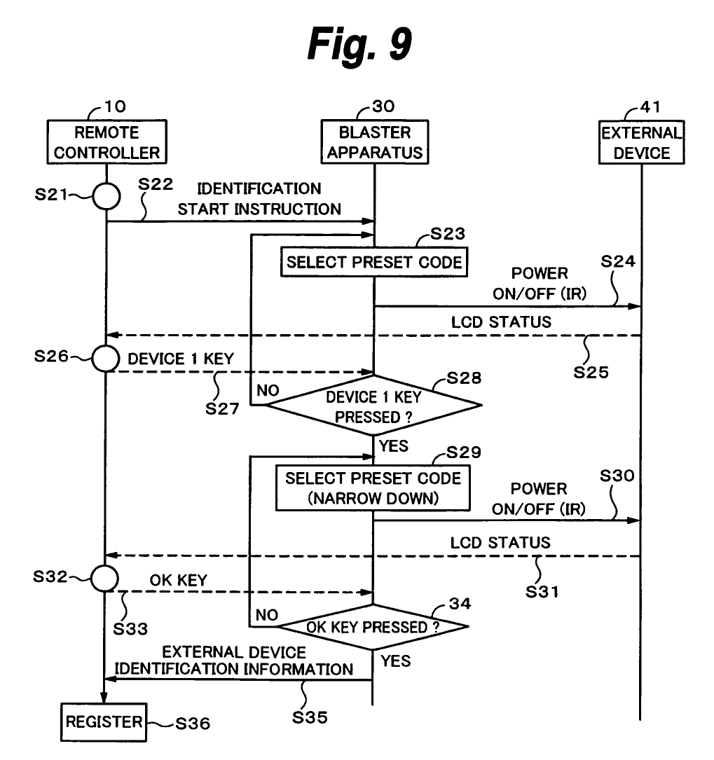

The identification start instruction contains information about the device designation key operated along with the identification start command. Based on information about the device designation key, one of a plurality of input terminals connected to a plurality of external devices is set up. In this example, since the device designation keys 23a, 23b, 23c, and 23d correspond to the device types, device types are narrowed down corresponding to the pressed device designation key. A video signal is input from one of the external devices 41a and 41b (denoted by 41 in FIG. 7, FIG. 8, and FIG. 9), connected to the selected input terminal, to the signal detection section 37.

At step S3, the blaster apparatus 30 selects a preset code that identifies an external device and that occurs when the power on/off key 22 is pressed. Preset codes are output from the tables corresponding to individual manufacturers for the narrowed device type. The preset codes are generated twice for each manufacturer so as to turn on and off the power. At step S4, the conversion section 33 generate Ir signals corresponding to power on/off operations and the light emitting device 35 emits corresponding infrared light signals.

Ir signals corresponding to power on/off operations for all manufacturer names stored in the memory 34 are successively generated. In the period for which the Ir signals are generated and output, a video signal is input from the external device 41 (at step S5). The signal detection section 37 monitors changes of the video signal (at step S6). When the external device 41 receives an Ir signal assigned to its manufacturer name, the power of the external device 41 is turned on and then turned off after a predetermined period has elapsed. When the power is turned on/off, the output video signal is changed. For example, when the power is turned on, a no-sound signal (nearly, 0 V) occurs. When the power is turned off, the terminal of the input video signal becomes open.

At step S6, changes of the video signal are detected and the control section 32 is informed thereof. Since the control section 32 controls generation of preset codes, it knows with what manufacture name of an Ir signal the video signal has changed.

The control section 32 transmits an RF signal of the manufacturer name of the external device 41 as device identification information determined from changes of the image signal detected at step S6 through the communication section 31 to the remote controller 10 (at step S7). The remote controller 10 registers the received device identification information to a non-volatile memory at step S8. Thereafter, the manufacturer name corresponding to the device designation key pressed when the identification was started is used. The foregoing device identification process is performed immediately after the external device is connected.

In this embodiment, device designation keys may not be necessary to be correlated with device types. In this case, not only manufacturer names, but preset codes of all device types are successively output. In addition, changes of an audio signal may be detected instead of those of a video signal as an output of an external device.

Next, with reference to a flow chart shown in FIG. 8, a second embodiment of the present invention will be described. The structure of hardware of the second embodiment is the same as that shown in FIG. 4 and can be accomplished by changing control of the control section 32.

First, at step S11, any key of the device designation keys 23a, 23b, 23c, and 23d and the OK key 25 are pressed simultaneously on the remote controller 10. At step S12, an RF signal containing an identification start instruction command is transmitted from the remote controller 10 to the blaster apparatus 30.

The identification start instruction contains information about the device designation key operated along with the identification start command. Based on information about the device designation key, one of a plurality of input terminals connected to a plurality of external devices is set up. In this example, since the device designation keys 23a, 23b, 23c, and 23d correspond to the device types, device types are narrowed down corresponding to the pressed device designation key.

At step S13, the blaster apparatus 30 selects a preset code that identifies an external device and that occurs when the power on/off key 22 is pressed. Preset codes are output from the tables corresponding to individual manufacturers for the narrowed device type. The preset codes are generated twice for each manufacturer so as to turn on and off the power. At step S14, the conversion section 33 generate Ir signals corresponding to power on/off operations and the light emitting device 35 emits corresponding infrared light signals.

Ir signals corresponding to power on/off operations for all manufacturer names stored in the memory 34 are successively generated. In the period for which the Ir signals are generated and output, the user monitors the status of a display device, for example, a liquid crystal display (LCD) that indicates the operation mode of the external device 41 (at step S15). Instead, the user may monitor the status of another display device, for example, a light emitting diode (LED) that indicates the power on/off status. The periods for changes of the Ir signals are set up for which the user can recognize the status changes of the display section and he or she can press the OK key 25.

When the user has recognized the status changes of the LCD of the external device, he or she presses the OK key 25 (at step S16). A key signal generated with the OK key 25 is transmitted to the blaster apparatus 30 (at step S17).

The blaster apparatus 30 monitors whether or not a key signal corresponding to the OK key 25 has occurred (at step S18). When the key signal corresponding to the OK key 25 has been received, the key signal is supplied to the control section 32. Since the control section 32 controls generation of preset codes, the control section 32 determines the manufacturer name according to timing at which the OK key 25 has been pressed (timing at which a corresponding key signal has been received).

The control section 32 transmits an RF signal of the manufacturer name of the external device 41 as device identification information determined from changes of the image signal detected at step S19 through the communication section 31 to the remote controller 10. The remote controller 10 registers the received device identification information to a non-volatile memory at step S20. Thereafter, the manufacturer name corresponding to the device designation key pressed when the identification was started is used. The foregoing device identification process is performed immediately after the external device is connected.

Next, with reference to a flow chart shown in FIG. 9, a third embodiment that can semi-automatically set up device identification information will be described. The structure of hardware of the third embodiment is the same as that shown in FIG. 4. The third embodiment can be accomplished by modifying the process of the control section 32.

First, at step S21, any key of the device designation keys 23a, 23b, 23c, and 23d and the OK key 25 are pressed simultaneously on the remote controller 10. At step S22, an RF signal containing an identification start instruction command is transmitted from the remote controller 10 to the blaster apparatus 30.

The identification start instruction contains information about the device designation key operated along with the identification start command. Based on information about the device designation key, one of a plurality of input terminals connected to a plurality of external devices is set up. In this example, since the device designation keys 23a, 23b, 23c, and 23d correspond to the device types, device types are narrowed down corresponding to the pressed device designation key.

At step S23, the blaster apparatus 30 selects a preset code that identifies an external device and that occurs when the power on/off key 22 is pressed. Preset codes are output from the tables corresponding to individual manufacturers for the narrowed device type. The preset codes are generated twice for each manufacturer so as to turn on and off the power. At step S24, the conversion section 33 generate Ir signals corresponding to power on/off operations and the light emitting device 35 emits corresponding infrared light signals.

Ir signals corresponding to power on/off operations for all manufacturer names stored in the memory 34 are successively generated. In the period for which the Ir signals are generated and output, the user monitors the status of a display device, for example, a liquid crystal display (LCD) that indicates the operation mode of the external device 41 (at step S25). Instead, the user may monitor the status of another display device, for example, a light emitting diode (LED) that indicates the power on/off status. There are two types of periods for changes of the Ir signals. When preset codes are initially selected at step S23, they are selected (changed) at short period (at high speed).

Ir signals corresponding to power on/off operations for all manufacturer names stored in the memory 34 are successively generated. In the period for which the Ir signals are generated and output, the user monitors the status of a display device, for example, a liquid crystal display (LCD) that indicates the operation mode of the external device 41 or the status of another display device (at step S25).

When the user has recognized the status changes of the LCD of the external device, he or she presses a predetermined device designation key (at step S26). In FIG. 9, the device designation key that is pressed is denoted by the device 1 key. When the device 1 key is pressed, a key signal corresponding thereto is transmitted to the blaster apparatus 30 (at step S27).

The blaster apparatus 30 monitors whether or not a key signal corresponding to the device 1 key has occurred (at step S28). When the key signal key is received, the received key signal is supplied to the control section 32. Since the control section 32 controls generation of preset codes, it can narrow down the manufacturer names according to timing at which the device 1 key has been pressed (timing for which the corresponding key signal has been received) to some extent. In other words, since preset codes are changed at high speed, the control section 32 can determine the range of the preset codes according to timing at which the device 1 key has been received.

When the determined result at step S28 denotes that the device 1 key has been pressed, the flow advances to step S29. At step S29, preset codes in the narrowed range are successfully generated. In this case, the period for which the preset codes are changed is set up to short such that the user can recognize the status change of the display section and press the OK key 25.

When the user has recognized the status changes of the LCD of the external device, he or she presses the OK key 25 (at step S32). A key signal generated with the OK key 25 is transmitted to the blaster apparatus 30 (at step S33).

The blaster apparatus 30 monitors whether or not a key signal corresponding to the OK key 25 has occurred (at step S34). When the key signal corresponding to the OK key 25 has been received, the key signal is supplied to the control section 32. Since the control section 32 controls generation of preset codes, the control section 32 determines the manufacturer name according to timing at which the OK key 25 has been pressed (timing at which a corresponding key signal has been received).

The control section 32 transmits an RF signal of the manufacturer name of the external device 41 as device identification information determined from changes of the image signal detected at step S35 through the communication section 31 to the remote controller 10. The remote controller 10 registers the received device identification information to a non-volatile memory at step S36. Thereafter, the manufacturer name corresponding to the device designation key pressed when the identification was started is used. The foregoing device identification process is performed immediately after the external device is connected.

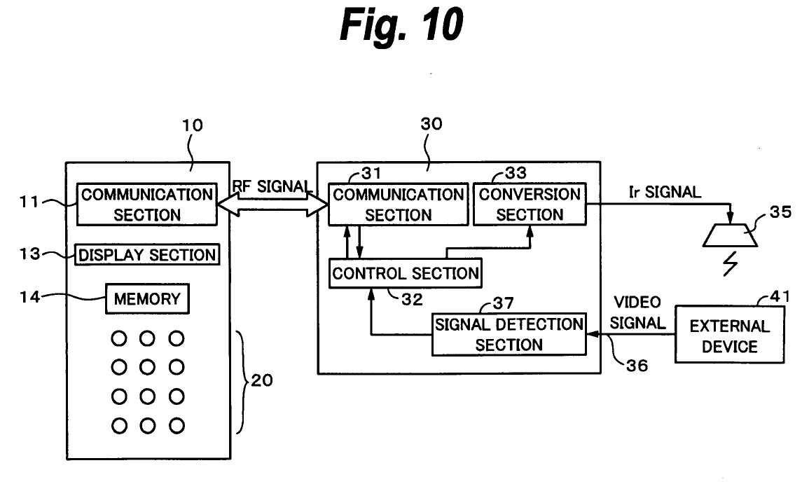

The structure of hardware of the first to third embodiments is as shown in FIG. 4. Preset codes are stored in the memory 34 of the blaster apparatus 30. However, like the structure shown in FIG. 10, the remote controller 10 may have, for example, an LCD display section 13 on the remote controller 10 and a memory 14 that stores preset codes. In this case, device designation keys of the remote controller 10 are correlated with external devices and preset codes corresponding to keys that have been pressed are transmitted as an RF signal to the blaster apparatus 30. The blaster apparatus 30 converts preset codes into an Ir signal and outputs it.

It should be understood by those skilled in the art that various modifications, combinations, sub-combinations and alternations may occur depending on design requirements and other factors insofar as they are within the scope of the appended claims or the equivalents thereof. For example, the radio communication system may be based on other than IEEE 802.15.4.

What is claimed is:

1. A remote-control-signal conversion apparatus which receives a radio control signal from a remote controller, converts the radio control signal into an infrared control signal, and transmits the infrared control signal to an external device,
wherein when the apparatus identifies the external device, the apparatus transmits a plurality of infrared control signals to the external device,
the apparatus identifies device identification information of the external device based on a response from the external device,
the apparatus radio transmits the identified device identification information to the remote controller,
the apparatus transmits the device identification information and a control code corresponding thereto as the infrared control signal received from the remote controller to the external device, and
the apparatus transmits the infrared control signal to the external device.

2. The apparatus as set forth in claim 1,
wherein the remote controller has a plurality of device designation keys and one of the plurality of device control keys is correlated with the device identification information.

3. The apparatus as set forth in claim 1,
wherein the device identification information of the external device is a code which represents a manufacturer name and a device type.

4. The apparatus as set forth in claim 1,
wherein when the apparatus is connected to a signal output terminal of the external device and the apparatus successively transmits a plurality of the infrared control signals to the external device, the apparatus identifies the device identification information based on signal changes of the signal output terminal.

5. The apparatus as set forth in claim 1,
wherein when the apparatus successively transmits the plurality of infrared control signals to the external device, the device identification information of the external device is identified based on changes of an indication of the external device.

6. A remote controller which transmits a radio control signal to an external device and controls it based on the radio control signal,
wherein the remote controller receives device identification information from a remote-control-signal conversion device and converts the radio control signal into an infrared control signal, and
wherein one of the plurality of device designation keys is correlated with the device identification information.

7. The remote controller as set forth in claim 6,
wherein the device identification information of the external device is a code which represents a manufacturer name and a device type.

8. A remote control apparatus, comprising:
a remote controller; and
a remote-control-signal conversion apparatus which receives a radio control signal from the remote controller, converts the radio control signal into an infrared control signal, and transmits the infrared control signal to an external device,
wherein when the apparatus identifies the external device, the apparatus transmits a plurality of infrared control signals to the external device,
the apparatus identifies device identification information of the external device based on a response from the external device,
the apparatus radio transmits the identified device identification information to the remote controller,
the apparatus transmits a radio control signal as the infrared control signal received from the remote controller to the external device, and
wherein the remote controller receives device identification information from the remote-control-signal conversion device,
one of the plurality of device designation keys is correlated with the device identification information, and
the remote controller transmits the device identification information designated by the device designation key to the remote-control-signal conversion apparatus.

9. A remote control method, comprising the steps of:
causing a remote-control-signal conversion apparatus to transmit a plurality of infrared control signals to an external device when the apparatus identifies the external device;
causing the apparatus to identify device identification information of the external device based on a response from the external device;
causing the apparatus to radio transmit the identified device identification information to the remote controller;
causing the apparatus to transmit a radio control signal as the infrared control signal received from the remote controller to the external device;
causing the remote controller to receive device identification information from the remote-control-signal conversion device;
causing the remote controller to correlate one of the plurality of device designation keys with the device identification information; and
causing the remote controller to transmit the device identification information designated by the device designation key to the remote-control-signal conversion apparatus.
